(19) United States
(12) Patent Application Publication
(10) Pub. No.: US 2018/0283269 A1
(43) Pub. Date: Oct. 4, 2018

(54) TURBOCHARGER FOR A VEHICLE ENGINE

(71) Applicant: GM GLOBAL TECHNOLOGY OPERATIONS LLC, DETROIT, MI (US)

(72) Inventors: Ran WU, Auburn Hills, MI (US); Louis P. BEGIN, Rochester, MI (US); Fanghui SHI, Bloomfield Hills, MI (US); Dingfeng DENG, Auburn Hills, MI (US)

(21) Appl. No.: 15/472,389

(22) Filed: Mar. 29, 2017

(51) Int. Cl. F02B 39/14; F02B 37/00

(52) U.S. Cl. CPC F02B 39/14; F02B 37/00

(57) ABSTRACT

A turbocharger for an internal combustion engine includes a center housing which defines a bore, a recess, and an annular groove. The annular groove and the recess may be configured to receive a fluid. A bearing is disposed within the bore proximate to the a turbine wheel such that the bearing, together with the rotating shaft, feeds fluid to the annular groove and recess. The shaft may be further coupled to the turbine wheel at a proximate end and a compressor wheel at a distal end. The shaft has a longitudinal axis and is supported by the bearing for rotation within the bore about the axis. The annular groove is in fluid communication with a drain gallery via a conduit.

### TECHNICAL FIELD

The present disclosure generally relates to turbochargers used in vehicle engines, and in particular, managing high density oil in the turbocharger housing.

### BACKGROUND

Internal Combustion Engines (ICE) are often called upon to generate considerable levels of power for prolonged periods of time on a dependable basis. Many such ICE assemblies employ a supercharging device, such as an exhaust gas turbine driven turbocharger, to compress the airflow before it enters the intake manifold of the engine in order to increase power and efficiency.

Specifically, a turbocharger is a centrifugal gas compressor that forces more air and, thus, more oxygen into the combustion chambers of the ICE than is otherwise achievable with ambient atmospheric pressure. The additional mass of oxygen-containing air that is forced into the ICE improves the engine's volumetric efficiency, allowing it to burn more fuel in a given cycle, and thereby produce more power.

A typical turbocharger employs a central rotor shaft that transmits rotational motion between an exhaust-driven turbine wheel and an air compressor wheel. Such a rotor shaft is generally supported inside a center housing by thrust and bearings (ball, journal, etc.) which are lubricated and cooled by engine oil and frequently receive additional cooling from specially formulated engine coolant. The exhaust gases that drive the turbine are prevented from entering the center housing by piston ring seals.

Turbochargers generally include a turbine housing for directing exhaust gasses from an exhaust inlet to an exhaust outlet across a turbine rotor. The turbine rotor drives a shaft and bearing supported in a center housing section. A compressor rotor is driven on the other end of the shaft. The compressor rotor is housed in a compressor housing which directs air from the air filter into the compressor and out to the charge air cooler. The center housing bearing cavity is protected from the exhaust gases on the turbine side and the compressed air from the compressor side by piston ring seals.

Crankcase oil is commonly used to lubricate the rotating bearing interfaces as well as the thrust surfaces that limit axial excursions of the rotor shaft. Temperatures above 800° C. can occur in the exhaust gas turbine in the case of Diesel engines and above 1,000° C. in the case of Otto-cycle engines. Heat migrating from the turbine housing and turbine wheel into the shaft and center housing raise the temperature high enough to degrade or “coke” the oil that comes in contact with the rotor shaft and center housing adjacent to the turbine stage. The area of the shaft between the shaft bearing and the turbine seal (referenced as the “coking land”) may reach temperatures as high as 300 to 400 degrees Celsius when the turbocharger is operating thereby causing oil to coke when the oil comes into contact with that region of the shaft. This built up coked oil may bind between the shaft adjacent to the turbine seal and the center housing. The binding restricts shaft rotation resulting in poor turbocharger boost performance.

Coking is an on-going issue with turbochargers given the very high operating temperatures and given that heat from the exhaust gas tends to be conducted along the turbine rotor and shaft. The turbine rotor is affixed to the turbocharger shaft and a turbine seal may be implemented near the joint between the turbine rotor, the shaft, and the center housing. As lubricating oil passes through the narrow gap between the shaft, the housing, the turbine rotor and the bearings, the oil may be heated to an elevated temperature as the lubricating oil contacts the heated shaft proximate to the turbine rotor. As indicated, coking is likely to occur in this region. Accordingly, there is a need for a simple, low cost and effective means to reduce coking in the center housing of a turbocharger.

The above information disclosed in this Background section is only for enhancement of understanding of the background of the invention, and therefore, it may contain information that does not form the prior art that is already known in this country to a person of ordinary skill in the art. Accordingly, there is a need for an improved turbocharger which reduces coking at the turbine shaft.

### SUMMARY

The present disclosure provides a turbocharger for an internal combustion engine. The turbocharger includes a rotating assembly and a center housing which defines a bore and an annular groove. The annular groove may be in fluid communication with the bore and may be configured to receive a fluid. A bearing may be disposed within the bore. The rotating assembly includes a shaft with a turbine wheel which is configured to be driven by post-combustion gasses emitted by the combustion chamber. The rotating assembly also includes a compressor wheel configured to pressurize the airflow for delivery to the combustion chamber. The shaft includes a longitudinal axis and is supported by the bearing system for rotation within the bore about the longitudinal axis.

The present disclosure also provides an internal combustion vehicle engine having a turbocharger. The engine includes an engine block and a turbocharger. The engine block defines at least one combustion chamber configured to receive an air-fuel mixture for combustion therein and configured to exhaust post-combustion gasses therefrom. The turbocharger may be configured to receive an airflow from the ambient and the post-combustion gasses from the combustion chamber of the engine block. The turbocharger further includes a bearing, a rotating assembly, and a center housing which defines a bore, an annular groove, having a recess and a shoulder within the annular groove. The annular groove with the recess and shoulder are configured to receive a fluid or high density oil. The recess and/or shoulder may be configured to direct the fluid or high density oil toward a drain gallery via a conduit. The bearing may be disposed within the bore. The rotating assembly may include a shaft with a turbine wheel configured to be driven by the post-combustion gasses and a compressor wheel configured to pressurize the airflow for delivery to the combustion chamber. The shaft may be supported by the bearing for rotation within the bore. The shaft may feed the fluid to the annular groove and recess during rotation.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 illustrates a vehicle engine having a turbocharger in accordance with various embodiments of the present disclosure.

FIG. 2 illustrates a schematic cross-sectional view of a turbocharger according to various embodiments of the present disclosure.

FIG. 3 illustrates an enlarged cross-sectional view of the center housing.

FIG. 4 illustrates an example, non-limiting bearing which may be used in the turbocharger of FIGS. 2 and 3.

FIG. 5 is an enlarged view of the oil flow within the cross section of the annular groove with shoulder.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by length; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

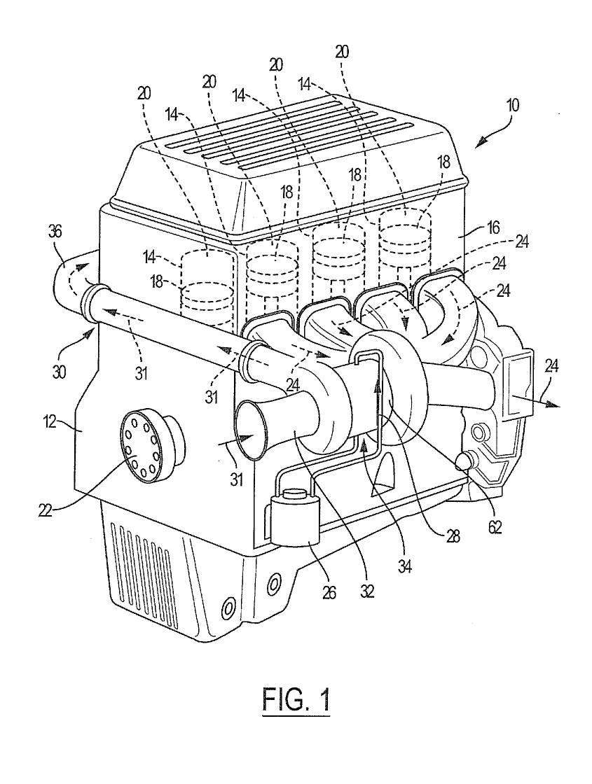

With reference to FIG. 1, an internal combustion engine 10 is shown in accordance with various embodiments of the present disclosure. The engine 10 also includes an engine or cylinder block 12 with a plurality of cylinders 14 arranged therein. As shown, the engine 10 also includes a cylinder head 16. Each cylinder 14 includes a piston 18 configured to reciprocate therein. Combustion chambers 20 are formed within the cylinders 14 between the bottom surface of the cylinder head 16 and the tops of the pistons 18. As known by those skilled in the art, combustion chambers 20 are configured to receive a fuel-air mixture for subsequent combustion therein.

Engine 10 also includes a crankshaft 22 configured to rotate within the cylinder block 12. The crankshaft 22 is rotated by the pistons 18 as a result of an appropriately proportioned fuel-air mixture being burned in the combustion chambers 20. After the air-fuel mixture is burned inside a specific combustion chamber 20, the reciprocating motion of a particular piston 18 serves to exhaust post-combustion gases 24 from the respective cylinder 14. The engine 10 also includes a fluid pump 26. The fluid pump 26 is configured to supply pressurized fluid or engine oil 28 to various bearings, such as that of the crankshaft 22. The pump 26 may be driven directly by the engine 10, or by an electric motor (not shown).

The engine 10 additionally includes an induction system 30 configured to channel airflow 31 from the ambient to the cylinders 14. The induction system 30 includes an intake air duct 32, a turbocharger 34, and an intake manifold 36. Although not shown, the induction system 30 may additionally include an air filter upstream of the turbocharger 34 for removing foreign particles and other airborne debris from the airflow 31. The intake air duct 32 is configured to channel the airflow 31 from the ambient to the turbocharger 34, while the turbocharger is configured to pressurize the received airflow, and discharge the pressurized airflow to the intake manifold 36. The intake manifold 36 in turn distributes the previously pressurized airflow 31 to the cylinders 14 for mixing with an appropriate amount of fuel and subsequent combustion of the resultant fuel-air mixture. While the present disclosure concentrates on the internal combustion engine 10 having a reciprocating configuration, other engine designs, such as a rotary engine that has combustion chambers 20, but not reciprocating pistons, are also envisioned.

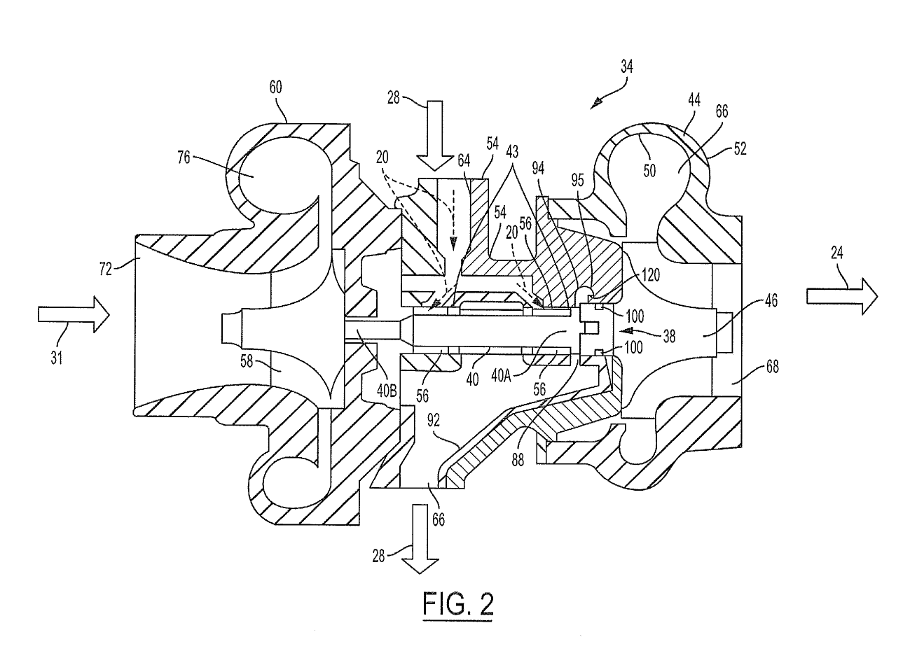

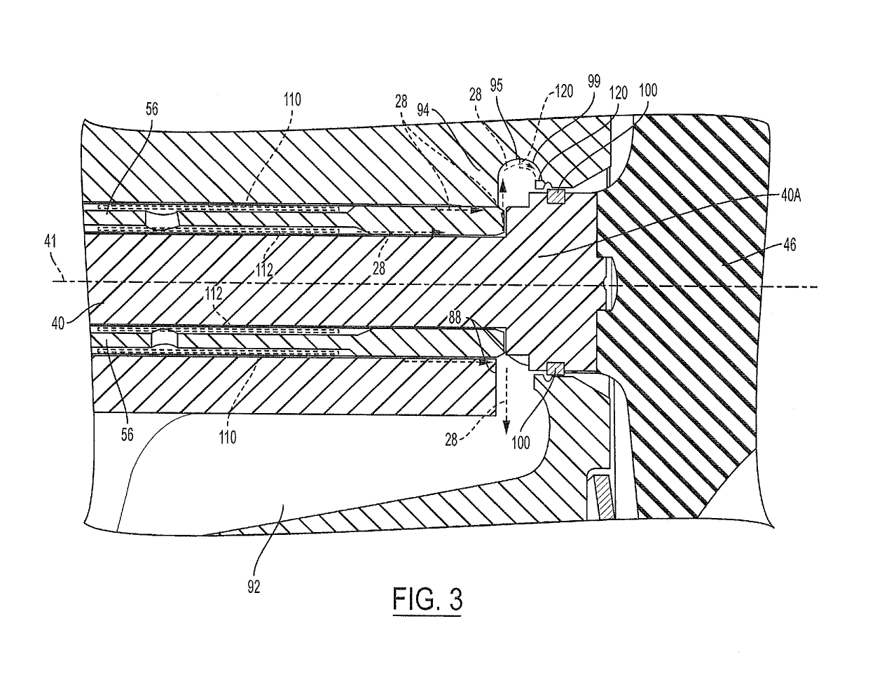

Referring now to FIG. 2, an example turbocharger 34 of the present disclosure is shown and generally described. The turbocharger 34 includes a rotating assembly 38 having a shaft 40 that is typically formed from steel and is defined by a first proximate end 40A (turbine end) and a distal second end 40B (compressor end). A turbine wheel 46 is mounted on the shaft 40 proximate to the first end 40A and configured to be rotated along with the shaft 40 about a longitudinal axis 41 (shown in FIG. 3) of the shaft 40 by post-combustion gasses 24 emitted from the cylinders 14. The turbine wheel 46 is disposed inside a turbine housing 44 that includes a volute or scroll 50. The scroll 50 receives the post-combustion exhaust gases 24 and directs the exhaust gases to the turbine wheel 46. The scroll 50 is configured to achieve specific performance characteristics, such as efficiency and response, of the turbocharger 34. As shown, the spinning turbine 46 is mounted on the same shaft as the compressor wheel 58. Therefore, as the turbine 46 spins, the compressor 58 spins too. The exhaust gas 24 leaves the car, wasting less energy than it would otherwise. Accordingly, the rotation of the turbine 46, the shaft 40 and the compressor 58 should not be impeded in order to provide optimum performance.

Referring again to FIG. 2, the turbocharger 34 may also generally include a turbocharger housing assembly 52 consisting of compressor housing 60, center housing 54 and turbine housing 44. Turbocharger housing assembly 52 includes a center section (center housing 54) receiving a pair of spaced apart bearings 56 (or a single bearing 56) and rotatably receiving therein an elongate shaft 40. A turbine wheel 46 is attached to or integrally formed with one end 40A of shaft 40—the turbine end 40A of the shaft 40. At the opposite end 40B of shaft 40—the distal end 40B of the shaft 40, a compressor wheel 58 is carried thereon and may be drivingly secured thereto by a nut threadably engaging the shaft 40.

The turbine housing 44 may be integral with the center housing 54 and defines an exhaust gas inlet leading to a radially outer portion of the turbine wheel 46. The turbine housing 44 also defines an exhaust gas outlet 68 leading from the turbine wheel 46. Similarly, a compressor housing 60 defines an air inlet 72 leading to the compressor wheel 58 and an air outlet (not shown) opening from a diffuser chamber. Therefore, the turbocharger 34 includes a center housing 54 with a bore 43 defined by the center housing 54, a bearing 56, and a rotating assembly 38. The bore 43 may be defined by the center housing 54 and having an annular groove 94 configured to receive a fluid. The bearing 56 may be disposed within the bore. The rotating assembly 38 includes the shaft 40 with a turbine wheel 46 and a compressor wheel 58. The turbine wheel 46 may be configured to be driven by the post-combustion gasses 24 (shown in FIG. 1) while the compressor wheel 58 may be configured to pressurize the airflow 31 for delivery to the combustion chamber 20.

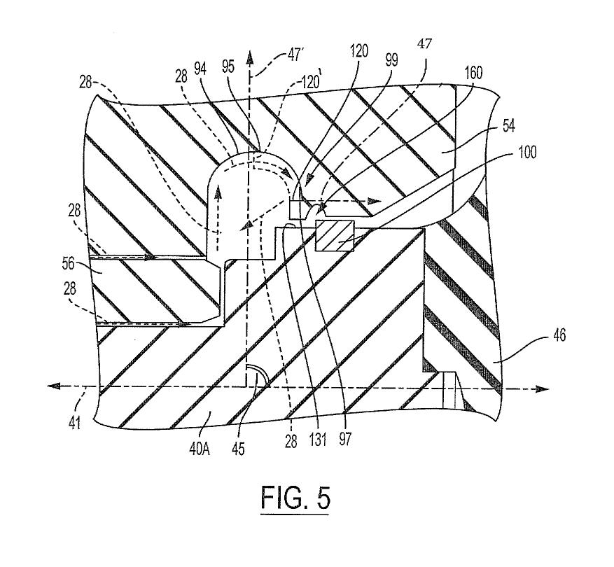

Upon shutdown of the engine supplying exhaust gasses to the inlet, both the source of heat energy and the source of cooling oil flow to the turbocharger cease to operate. However, both the turbine housing 44 and turbine wheel 46 are hot and hold a considerable quantity of residual heat. This residual heat is conducted to the cooler parts of the turbocharger much as heat was conducted during operation thereof. However, no cooling oil flow or internal compressor air flow is now present. Consequently, the temperature of shaft 40 and center housing 54 progressively increase for a time over their normal operating temperatures. This temperature increase, if uncontrolled, could result in heightened temperatures at the shaft 40, the turbine housing 44, center housing 54 as well as the lubricant drain gallery 92. Heightened temperatures in these regions at the coking land 131 (shown in FIG. 5) create an issue for oil 28. However, the present disclosure provides for a vehicle engine and turbocharger 34 which prevents excessive oil 28 from collecting at the coking land 131 when the turbocharger 34 is operating and when the turbocharger 34 is not in motion. As shown in FIG. 5, coking land 131 is the surface of the shaft 40 that is in close proximity to the center housing 54. As shown, there is generally a gap 160 between center housing 54 and the coking land 131 (area of the shaft 40 between the turbine seal 100 and the bearing 56). Moreover, the relatively low mass and low heat storage capacity of the turbine wheel 46 are minor additional factors which further contribute to the problem of coking at the shaft 40. Accordingly, it is understood that heat transfer within turbocharger may occur from the turbine wheel 46 to the shaft 40 via a conductive path between the materials.

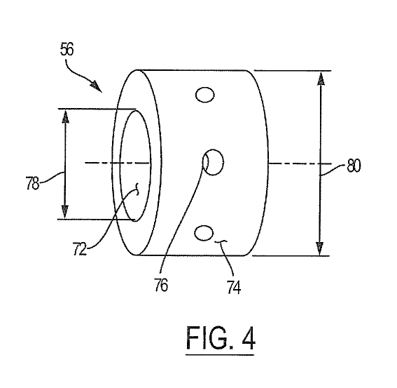

As shown in FIG. 2, oil 28 enters into the turbocharger via oil inlet 64 and is routed to at least one bearing 56 for the turbocharger shaft 40. While one semi-floating journal bearing 56 maybe used, it is understood that multiple, fully floating ball bearings may also be alternatively used for a single shaft 40. Thus, the bearing 56 of the present disclosure may be configured as a fully-floating bearing or a semi-floating bearing such that the fluid fed therefrom comes from a first fluid film 110 (FIG. 3) between the bore and the bearing 56 and a second fluid film 112 (FIG. 3) between the bearing 56 and the shaft 40. With reference to FIG. 4, the bearing 56 may also include a first surface 72 defined by an inner diameter 78, a second surface 74 defined by an outer diameter 80 with a passage 76 that connects the first and second surfaces 72, 74. It is further understood that multiple passages 76 may be defined in the bearing 56 which connect the first and second surfaces 72, 74.

Referring now to FIGS. 3 and 5, a turbocharger 34 in accordance with the various embodiments of the present disclosure may be generally described in greater detail wherein high density oil 28 is directed away from the coking land 131—thereby reducing turbocharger 34 binding/failure. As shown, the annular groove 94 formed in center housing 54 is configured to initially receive oil 28 flung radially outward by the spinning motion of shaft 40 and/or the bearing 56. Due to the centrifugal force of the fluid/oil 28 flung from the shaft 40, the fluid/oil 28 generally travels away from the shaft and then contacts the outer curved surface 95 of the annular groove 94 and the oil 28 subsequently flows toward shoulder 120 and recess 97 (shown in FIG. 5). Recess 97 is defined by the region 97 between the portion 99 of the curved surface 95 (which is disposed across from shoulder 120) and the shoulder 120 itself. When the rotating assembly 38 is in motion, the recess 97 and shoulder 120 catches high density oil 28 that is received in the annular groove 94 and by doing so, directs high density oil 28 toward conduit 88 (shown in FIG. 3) away from the coking land 131 and directs the high density oil 28 toward the bearing 56 (having a lower temperature than the coking land 131). Similarly, when the rotating assembly 38 ceases motion, the recess 97 and shoulder 120 catches and collects high density oil 28 that was flung from the motion of rotating assembly 38 and substantially directs the collected high density oil 28 toward conduit 88 which is in fluid communication via the recess 97 formed in the annular groove 94.

It is understood that shoulder 120 (shown in solid FIG. 5) may be disposed in a manner/orientation 47 where the shoulder 120 is substantially parallel to the axis 41 (FIG. 3) of the shaft 40. However, the shoulder 120 may also be disposed in a manner/orientation 47′ where the shoulder 120′ (shown in phantom in FIG. 5) is substantially perpendicular to the axis 41 (FIG. 3) of the shaft 40. It is understood that the shoulder 120 may be disposed/oriented anywhere within the range where the angle 45 (shown in FIG. 5) between the shoulder orientation 47 and the shaft axis 41 may be anywhere from approximately zero degrees to ninety degrees—(from horizontal/parallel as shown in solid to vertical/perpendicular as shown in phantom) so that the shoulder 120, 120′ may direct all or most of the high density oil 28 received in annular groove 94 away from the coking land 131 (toward bearing 56 and/or toward conduit 88 shown in FIGS. 2 and 3). Therefore, the shoulder 120, 120′ may be oriented at an angle (shown as element 45 in FIG. 5) relative to the axis 41 of the shaft 40 and the angle (element 45 in FIG. 5) of the shoulder may be any angle which falls in the range of approximately zero degrees (as shown by shoulder 120) to approximately ninety degrees (as shown by shoulder 120′ in phantom) relative to the axis 41 of the shaft 40.

As shown, in order to drain oil 28 from the annular groove 94 and recess 97, the center housing 54 defines a conduit 88 opening downwardly from the annular groove 94 into drain gallery 92 so that oil which is collected in groove 94 as well as in recess 97 may be drained into oil drain gallery 92 with the help of gravity. Again, coking land 131 may be the region of the shaft 40 and the center housing 54 where coked oil traditionally tends to accumulate in prior art designs without shoulder 120. The drain gallery 92 further includes an oil outlet 66 so that the oil 28 (shown in FIGS. 2 and 5) may be routed out of the turbocharger 34 from the oil drain gallery 92. With reference to FIG. 1, a first embodiment of the present disclosure may relate to a vehicle engine having one or more combustion chambers 20 which cooperate with the vehicle engine's turbocharger 34. The turbocharger 34 of FIG. 1 may be configured to receive an airflow 31 from the ambient so that the turbocharger 34 feeds air into the combustion chambers 20 of the vehicle engine. The post-combustion gases 24 from the combustion chambers may be fed into the turbine of the turbocharger.

Again, similar to the turbocharger 34 generally described earlier, an embodiment regarding a vehicle engine with a turbocharger of FIG. 1 may include a vehicle engine having a turbocharger 34 wherein the combustion chamber(s) of the vehicle engine is in fluid communication with a compressor 58 and a turbine 46 of the turbocharger 34. The turbocharger 34 further includes a center housing 54 (shown in FIG. 2), a bore 43 defined by the center housing 54, a bearing 56, and a rotating assembly 38. The bore 43 may further define an annular groove 94 proximate to the turbine wheel 46. The annular groove 94 may be configured to receive a fluid or high density oil 28. The bearing 56 may be disposed within the bore 43. The rotating assembly 38 includes the shaft 40 with a turbine wheel 46 and a compressor wheel 58. The turbine wheel 46 may be configured to be driven by the post-combustion gasses from the combustion chamber of the vehicle engine while the compressor wheel 58 may be configured to pressurize the airflow for delivery to the combustion chamber.

The shaft 40 may include a longitudinal axis 41 (shown in FIGS. 3 and 5) wherein the shaft 40 may be supported by the bearing 56 for rotation within the bore 43 about the longitudinal axis 41. As shown in FIG. 3, the bearing 56 may be configured as a fully-floating or a semi-floating bearing 56 such that the fluid fed therefrom (to the annular groove 94) comes from a first fluid film 110 between the bore and the bearing 56 and a second fluid film 112 between the bearing 56 and the shaft 40. With further reference to FIG. 4 again, the bearing 56 may include a first surface 72 defined by an inner diameter 78, a second surface 74 defined by an outer diameter 80, and a passage 76 that connects the first and second surfaces 72, 74. It is understood that multiple passages 76 may also be implemented in the bearing 56 to fluidly connect the first and second surfaces 72, 74. The bearing 56 may, but not necessarily, be a brass bushing.

Referring back to FIGS. 3 and 5, the annular groove 94 may be configured to receive fluid (engine oil 28) from the spinning shaft 40 and/or bearing 56 via centrifugal force. Upon contacting the outer surface 95 of the annular groove 94, the fluid or oil 28 may flow toward recess 97 (and retained by shoulder 120) so that the fluid or oil 28 may either flow into the drain gallery 92 via conduit 88, or flow away from the coking land 131 due to the configuration of the shoulder 120. Shoulder 120 is operatively configured to deflect the oil 28 so that the oil 28 may directed or projected toward the bearing 56. As noted, the recess 97 and annular groove 94 may be in communication with the drain gallery 92 via a conduit 88 defined in the center housing 54. Moreover, the annular groove 94 may, but not necessarily, be defined in the housing 44, 54 between the bearing 56 and the turbine wheel 46 as shown. It is understood that the annular groove 94 may be machined and/or cast into the center housing 54.

Another embodiment of the present disclosure may relate to a turbocharger alone wherein the turbocharger includes a center housing 54, a bore 43 defined by the center housing 54, a bearing 56 and a rotating assembly 38. The bore 43 may further define an annular groove 94 and recess 97 configured to receive a fluid or high density oil 28 from the rotating shaft 40 and/or bearing 56. The annular groove 94 may, but not necessarily, surround at least a portion of the proximate end 40A of the shaft 40. Again, the annular groove 94, associated shoulder 120, and recess 97 (as described earlier) may be formed in the center housing 54 in the region between the bearing 56 and the turbine seal 100 as shown in FIGS. 3 and 5.

In the embodiment with the turbocharger 34 alone, the shaft 40 may include a longitudinal axis 41 wherein the shaft 40 may be supported by the bearing 56 for rotation within the bore 43 about the longitudinal axis 41 (FIGS. 3 and 5). As previously, the annular groove 94, shoulder 120, and recess 97 may be configured to receive high density fluid 28 which is flung from the spinning shaft 40 and/or bearing 56 via centrifugal force. It is understood that oil 28 travels along the spinning shaft 40 into the annular groove 94, against outer curved surface 95, and then into recess 97 which is defined, in part, by the shoulder 120. The excess oil 28 will then be collected in recess 97 and then drain from the recess 97 and/or annular groove 94 into the drain gallery 92 via the conduit 88 when the shaft 40 (rotating assembly 38) ceases motion. When the rotating assembly 38 is in motion, the annular groove 94, the shoulder 120, and the recess 97 is particularly useful for redirecting the continuous flow of high density oil 28 away from the coking land 131—towards the bearing 56 and through conduit 88 into the oil drain gallery 92. Shoulder 120 may be configured to project or direct oil 28 which travels into recess 97 toward the bearing 56 given that the shoulder 120 may be substantially perpendicular to the outer curved surface 95 of the annular groove 94. As noted earlier, the shoulder 120 may have an orientation 47 which falls anywhere within the range wherein the angle 45 between the shoulder orientation 47 and the shaft axis 41 may anywhere from approximately zero degrees to ninety degrees—as shown in FIG. 5 (via shoulder 120′ in phantom at ninety degrees and shoulder 120 in solid at zero degrees) and described earlier.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An internal combustion engine comprising:
an engine block defining at least one combustion chamber configured to receive an air-fuel mixture for combustion therein and configured to exhaust post-combustion gasses therefrom; and
a turbocharger configured to receive an airflow from the ambient and the post-combustion gasses from the combustion chamber, the turbocharger including:
a center housing further comprising;
a bore, an annular groove, a recess and a shoulder defined by the center housing, the annular groove, the shoulder, and the recess each being configured to receive a fluid and to direct the fluid toward at least one of a conduit or a bearing disposed within the bore; and
a rotating assembly having a shaft with a turbine wheel configured to be driven by the post-combustion gasses and a compressor wheel configured to pressurize the airflow for delivery to the combustion chamber, the shaft being supported by the bearing for rotation within the bore and feeding the fluid to the annular groove, the recess and the shoulder during rotation.

2. The engine of claim 1 wherein the shoulder may be oriented substantially parallel to an axis of the shaft.

3. The engine of claim 1 wherein the shoulder may be substantially perpendicular to an axis of the shaft.

4. The engine of claim 1 wherein the shoulder may be oriented at an angle relative to the axis of the shaft, the angle being between approximately zero degrees to approximately ninety degrees.

5. The engine of claim 1 wherein the shaft defines a proximate end and a distal end.

6. The engine of claim 5 wherein the center housing defines the annular groove at the proximate end of the shaft.

7. The engine of claim 6 wherein the bearing is configured as one of a fully-floating ball bearing or a semi-floating journal bearing and the fluid fed from the bearing comes from a first fluid film between the bore and the bearing and a second fluid film between the bearing and the shaft.

8. The engine of claim 7 further wherein the bearing includes a first surface defined by an inner diameter, a second surface defined by an outer diameter, and a passage that connects the first and second surfaces.

9. The engine of claim 8 wherein the annular groove is in fluid communication with a drain gallery.

10. The engine of claim 8 wherein the bearing is a brass bushing.

11. The engine of claim 9 wherein the conduit couples the annular groove to the drain gallery.

12. A turbocharger for an internal combustion engine having a combustion chamber, the turbocharger comprising:
a center housing;
a bore, an annular groove and a shoulder defined by the center housing, annular groove and shoulder being in fluid communication with the bore and being configured to receive a fluid and then to direct the fluid toward a conduit and a bearing disposed within the bore; and
a rotating assembly having a shaft being supported by the bearing for rotation within the bore and feeding the fluid to the annular groove when the rotating assembly is in motion.

13. The turbocharger as defined in claim 12 wherein the shoulder may be oriented at an angle relative to an axis of the shaft, the angle of the shoulder being between approximately zero degrees to approximately ninety degrees relative to the axis of the shaft.

14. The turbocharger as defined in claim 12 wherein the shoulder may be oriented substantially parallel relative to an axis of the shaft.

15. The turbocharger as defined in claim 12 wherein the shoulder may be oriented substantially perpendicular relative to an axis of the shaft.

16. The turbocharger as defined in claim 12 wherein the shaft includes a proximate end and a distal end.

17. The turbocharger of claim 16 wherein the center housing defines the annular groove proximate to the turbine wheel.

18. The turbocharger of claim 17 wherein the bearing is configured as one of a fully-floating ball bearing or a semi-floating journal bearing, and the fluid fed from the bearing comes from a first fluid film between the bore and the bearing and a second fluid film between the bearing and the shaft.

19. The turbocharger of claim 18 further wherein the bearing includes a first surface defined by an inner diameter, a second surface defined by an outer diameter, and a passage that connects the first and second surfaces.

20. The turbocharger of claim 19 wherein the annular groove is in fluid communication with a drain gallery via the conduit.
